(19) United States
(12) Patent Application Publication
(10) Pub. No.: US 2011/0041116 A1
(43) Pub. Date: Feb. 17, 2011

(54) FORMAL ANALYSIS DRIVEN BASED EVOLUTION OF REQUIREMENTS SPECIFICATIONS

(75) Inventors: Prahladavaradan Sampath, Bangalore (IN); Prasanna Vignesh V. Ganesan, Chennai (IN); Ambar A. Gadkari, Bangalore (IN); Ramesh Sethu, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/541,786

(22) Filed: Aug. 14, 2009

(51) Int. Cl. G06F 9/44

(52) U.S. Cl. 717/101

(57) ABSTRACT

A method for developing a specification includes receiving a plurality of requirements that define the functionality of the specification, wherein the plurality of requirements are expressed using a formal model. The method further includes analyzing the plurality of requirements using algorithms and determining if the plurality of requirements satisfies a predetermined set of criteria. The method further includes generating a summary of the formal analysis and refining the requirements by incorporating corrected analysis results.

### BACKGROUND

Although dependent on a particular design model, a software development process (i.e., software life cycle) generally includes tasks such as developing requirements, designing and testing models and developing code. In general, a requirement is a documented need of how a particular product or service should perform. More particularly, a requirement is a statement that identifies a necessary attribute, capability, characteristic or quality of a system. Requirements are used as inputs into the design stages of a product development process and illustrate what elements and functions are necessary for a particular application.

A requirements development phase may be preceded by a feasibility study or a requirements gathering stage wherein requirements are elicited from customers, users or other stakeholders. The requirements phase may be also be broken down into analysis, specification and verification stages wherein the requirements are documented and checked for consistency, completeness, correctness and potential ambiguities.

Developing requirements, also referred to as requirements engineering, is a critical step in the development process of a software intensive system. It is well established among those skilled in the art of software design that a large percentage of defects in a system can be traced back to defects in the requirements specification. The cost of fixing requirement errors increases exponentially over the design, implementation and testing stages of system engineering.

Requirements engineering sits at the boundary between system design and user expectations and is responsible for ensuring the quality of a requirements specification. To this end, requirements engineering should be implemented in a way that ensures that the requirements specification is precise, unambiguous, consistent, and complete, and meets the expectations of the stakeholders.

There are a number of tools and methods that have been developed for supporting requirements engineers in developing quality requirements specifications. The tools vary in functionality and range from providing repositories for storing specifications to providing analysis engines based on formal methods for analyzing specifications. A number of tools also provide capabilities for configuration management and version management of specifications, and also for supporting traceability of requirements across different stages of the systems engineering life cycle. What is needed, however, is an automated system configured to provide an iterative development process that directly incorporates formal analysis results into the developmental stages of the requirements specification.

### SUMMARY

A method for developing a specification includes receiving a plurality of requirements that define the functionality of the specification, wherein the plurality of requirements are expressed using a formal model. The method further includes simulating the plurality of requirements using formal analysis and determining if the plurality of requirements satisfies a predetermined set of criteria. The method further includes generating a summary of the formal analysis and modifying at least one of the plurality of requirements if at least one of the predetermined set of criteria is not satisfied.

Additional features will become apparent from the following description and appended claims, taken in conjunction with the accompanying drawings.

### BRIEF DESCRIPTION OF THE DRAWINGS

FIG. 1 illustrates an exemplary requirements specification development system according to an embodiment;

FIG. 2 illustrates an exemplary process for developing a requirements specification, according to an embodiment;

FIG. 3 illustrates an exemplary focus operation is a state-machine; and

FIG. 4 illustrates an exemplary state-machine clause.

### DETAILED DESCRIPTION OF THE EMBODIMENTS

The embodiments described herein relate generally to a system and process for developing a requirements specification and, more particularly, to a method for directly incorporating formal analysis results into the developmental stages of the requirements specification. The system includes a software development tool configured to implement an iterative development process that tightly integrates formal analysis algorithms into a feedback-loop enabling the results of the analysis to be incorporated into the specification.

Using this approach, the analysis algorithms and the specification formalism are complementary to one another in that the data-structures representing the analysis results are the same as the data-structures for the specification clauses. This allows analysis results to be directly used as a specification mechanism or item. In other words, a user can specify an intended result for performing a particular analysis on the specification. This system provides a very close interaction between the activities of the specification and analysis. This close interaction enables a closed-loop iterative process for specification and analysis.

The method transforms textual requirements into a formal model of requirements that are provably consistent and complete. The method bridges a gap between informal requirements and formal design models, such as statecharts that are generally used in model-based software design. Since the method internally uses formal models, it enables rapid iterative development of the requirements specification, supported by analysis algorithms operating on the specification. The overall method includes developing the specification in small increments. Each increment of the specification is followed by an application of various analysis algorithms that are designed to provide feedback to the user by either summarizing the specification at any given point in the development process, or by identifying logical defects in the specification. The summary information generated by the analysis algorithms can be incorporated into the specification as a requirement, thereby reinforcing and refining the specification.

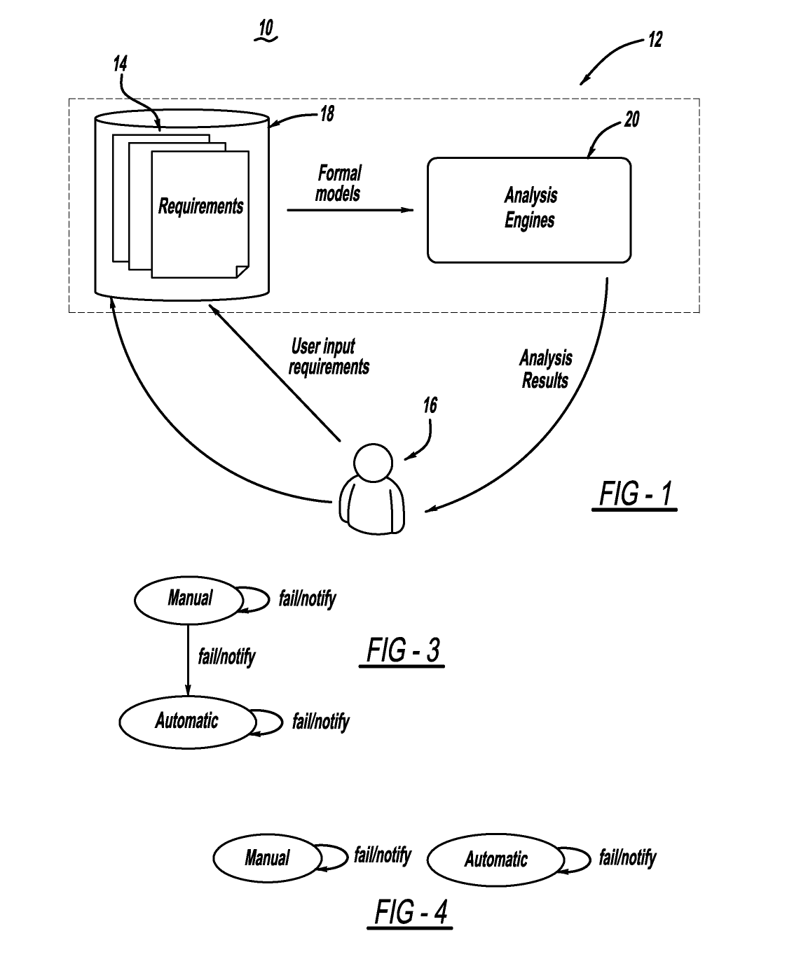

FIG. 1 illustrates an exemplary requirements development system 10 having a software development tool 12 configured to receive input requirements 14 from a user 16. In one embodiment, the user 16 may be, for example, a software engineer, a requirements engineer or a subject matter expert.

The requirements 14 can be expressed using a variety of different design languages supported by the requirements specification. Design languages, which are often referred to as formalisms, may be graphical or textual in nature and may include, without limitation, transition systems (e.g., state machines), event sequence charts (e.g., scenario or sequence diagrams) and structured English programming. In this way, the user 16 has the capability to develop requirements 14 using different formalisms. This in turn allows the specification to involve interaction between components of a system specified by different formalisms and be stored as one unified model allowing simplified import and export to other system tools. The requirements may be stored and/or processed by a database 18.

The formal models are evaluated by analysis engines 20, which include a plurality of algorithms configured to simulate the specification requirements 14 as represented by the formal models (i.e., formalisms). The analysis engines 20 are configured to explore the consequences of what the requirements have specified at any given point in the specification development process. In particular, the analysis engines 20 evaluate the specified requirements for a predetermined set of criteria. The results of the analysis are summarized and returned to the user 16 who can then chose to inspect the results and add them to the specification, or declare upfront that all analysis results are to be added to the requirements specification as a new specification item. Adding analysis results specifies additional constraints to the specification so that the results of any further analyses have to agree with the analysis result (and additional constraint) being added, thereby refining the specification. The ability to review and modify the analysis result and refine the specification based on the results of the analysis creates a feedback loop that provides a closed-loop process for developing a requirements specification. Thus, errors or defects in the specification are identified at the developmental stage of the process and can be corrected by amending the requirements, as discussed further below.

In one approach, the set of criteria includes checking the requirements for defects relating to correctness, completeness, consistency and ambiguity. The specification being correct refers to the whether the documented requirements accurately reflect the requirements of the stakeholders (i.e., anyone who has an interest in the system, such as users, testers, development team, management, etc.). A complete specification clearly identifies its scope and completely specifies all requirements within that scope with no missing information.

A specification is consistent when there are no portions of the specification that contradict one another and the specification is fully consistent with all authoritative external documentation. In other words, a logical inconsistency in a specification may define two actions for one condition wherein the actions themselves are inconsistent. For example, in an automotive system one requirement may specify that condition “A” results in action “X,” wherein X is a braking function, while another requirement may specify that condition “A” results in action “Y,” which is an accelerating function. Since an automobile cannot accelerate while braking, the two requirements are logically inconsistent.

For a specification to be unambiguous, it should be precise and leave no room for multiple interpretations by different people. The requirements should be concisely stated without recourse to technical jargon, undefined acronyms, or other esoteric verbiage. The specification should express objective facts and be subject to only one interpretation. Vague subjects, adjectives, prepositions, verbs, subjective phrases, negative statements and compound statements are avoided. In general, formally defined languages and mathematics are definitive and non-ambiguous.

Upon providing the analysis results, the software development tool 12 provides the user 16 with the capability to “focus” on a particular portion of the specification that has been identified with a defect. By focusing on the defective portion of the specification, the user 16 has the ability to isolate and analyze the root cause of the defect. The user 16 may then generate an alternative model that corrects the defect. This model, which in essence modifies a condition associated with a requirement, can be incorporated back into the specification and re-analyzed checking for any further defects.

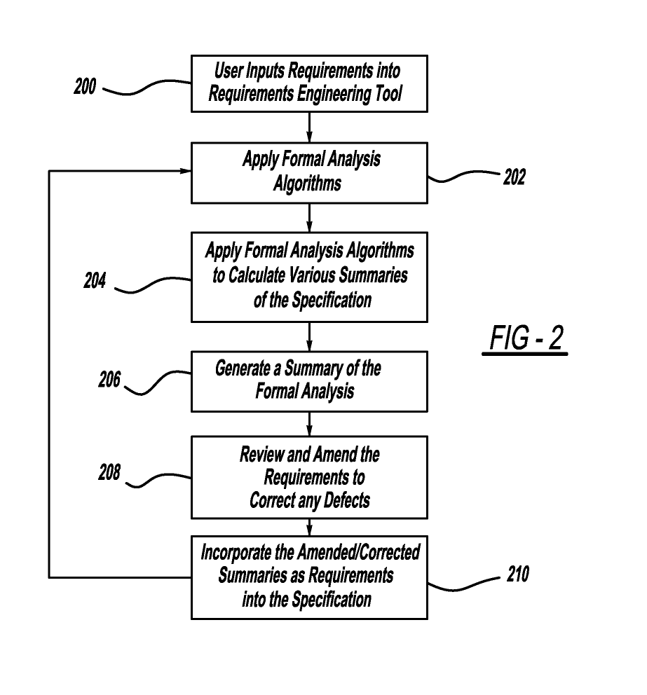

FIG. 2 illustrates an exemplary method for developing requirements. At step 200, a user 16 inputs requirements into software development tool 12. The requirements may be in the form of any suitable design language, including but not limited to, transition systems, event sequence charts and structured English programming. The requirements, expressed using formal models, are simulated by the analysis engines 20 at step 202 using formal analysis. The formal analysis applies a plurality of algorithms at step 204 to determine if the requirements 14 satisfy the predetermined set of criteria, which in at least one embodiment, includes checking the requirements 14 to determine if they are correct, consistent, complete and non-ambiguous. A summary of the formal analysis is generated at step 206 and provided to the user 16. At step 208 the analysis results may be corrected according to any defects identified by review of the analysis results. These corrected analysis results are then incorporated into the specification at step 210. One may note that correcting the analysis result and incorporating it into the specification is distinctly different from directly correcting the specification. A suitable analogy would be finding a bug while testing software. Suppose a program P gives an incorrect output O2 instead of the correct output O1. Once this defect is found, it is possible to change the code of P to fix this defect (this is analogous to correcting the specification), or it may be possible to just “declare” that P should produce the output O1 (this is analogous to correcting the analysis result). As we can see, correcting the analysis result and incorporating it into the specification by “declaring” it as the “expected” analysis result is a far more powerful operation than correcting the specification.

The following is a specific example of a process for developing a requirements specification using state-machines. The specifications are developed using a Structured Transition Systems (STS) formalism, which is introduced by example below. The method presented addresses each of the criteria for requirements set forth above. By virtue of having a formally defined language for the specification, the attribute of being precise and unambiguous is already met. The method uses analysis algorithms for automatically detecting inconsistencies and incompleteness in the specification.

The following illustrates a method using a fragment of the requirements for an embedded controller. The fragment focuses on the failure and recovery behavior of a controller. The high-level requirements are summarized as follows. The feature has two modes of operation: a) Manual Mode and b) Automatic Mode. The feature has the following states of operation: a) Disabled; b) Off; c) Engaged; and d) Failed. The feature is initially in the Off state of operation and the user has to be notified of a failure in the feature. Once a failure occurs, the feature has to be reset to recover and resume normal operations. The reset event will re-initialize the feature to its initial state.

The above modes and states of operation are representative of the sort of requirements specifications encountered in some automotive applications. The method begins by first identifying the events in the specification and classifying them as either input or output events. In the above case, we can identify the following events: 1) fail, which is an input event; 2) reset, which is an output event; and 3) notify, which is an output event. As part of this example, an output event ε is added to indicate that no action needs to be taken by the feature.

The next step in the method is to identify all the valid states in the specification. In this example, only the modes of operation and states of operation of the feature are of interest. In this specification each combination of Mode and State values is permissible. Therefore, there are 4×2=8 valid states for this specification as shown below:

| Mode | State |
|---|---|
| Manual | Disabled |
| Manual | Off |
| Manual | Engaged |
| Manual | Failed |
| Automatic | Disabled |
| Automatic | Off |
| Automatic | Engaged |
| Automatic | Failed |

In this example, we refer to particular valuations of state-variables values as states, and represent such states as a tuple of values, the state-variables in question being clear from the context. For example, the tuple <MANUAL, DISABLED> represents the state where the state-variable Mode has value MANUAL, and the state-variable State has the value DISABLED.

The STS language provides a number of language constructs to specify state transition behavior. These constructs can be used to express the textual feature requirements. One of the requirements can be expressed as a transition to a FAILED state on occurrence of the fail event. Once in a FAILED state, transitions on the fail should remain in the FAILED state. This can be expressed using the STS construct for simple transitions as shown below.
In any state the event “fail” will transition to a state where the predicate “fail” holds and outputs the action “notify We use the notation”

$$true \begin{matrix}fail \\ notify\end{matrix} fail$$

to stand for the above specification, where the predicate fail identifies all states where the State variable evaluates to FAILED.

The feature being initially in the Off state is expressed by an initialization construct of STS.
Initialize feature to “off”
   Where “off” is defined as the State variable taking the value of OFF.

Once a failure occurs, the feature has to be reset to recover and resume normal operations. The reset event will re-initialize the feature to its initial state. This behavior on the reset event is modeled using the simple transition:
In any state the event “reset” will transition to a state where the predicate “off” holds and will output the empty action We use the notation

$$true \begin{matrix}reset \\ ∈\end{matrix} off$$

to stand for the above specification. At this state, all the requirements given in the textual specification have been formalized using the constructs of the STS language.

A number of different analyses can be performed on the specification, the most important of which is to check for consistency and completeness. These analysis algorithms have been implemented in the software development tool to provide interactive feedback to the user as the specification is being developed.

First checking for consistency, we find that the specification as it stands is consistent. However, checking for incompleteness, the analysis reports that the event fail, in the state <MANUAL,ENGAGED>, can result in a transition to either <MANUAL,FAILED> or <AUTOMATIC,FAILED>.

The incompleteness analysis has revealed that the specification is not complete with respect to changes in the Mode state-variable when specifying the transition on event fail. In fact, this information is missing from the informal specification given earlier.

At this point, the specification can be analyzed by focusing on the state-variable Model. The result of the focus operation is a “summary” state-machine whose states are just the different valuations of the Model state-variable and whose transitions specify the behavior with respect to just the Mode state-variable—in other words, it is a predicate-abstraction of the specification. The result of focusing on Mode is shown in FIG. 3.

However, a more sensible behavior is to require that a transition cause by fail should not change the Mode state-variable. In other words, the result of focusing on Mode is expected to be the state-machine of FIG. 4—where there is not transition between manual and automatic on the event fail.

The STS language allows the user to specify this as part of the specification by importing the state-machine specified in FIG. 4 as a clause. This clause specifies the state-machine that is the result of analyzing the specification using the focus operation.

At this point, the consistency and completeness analyzes evaluation reports that the specification is both consistent and complete. However, at this point, the specification may be incorrect—the user might have unwillingly specified the wrong behavior. There is no general algorithm for detecting incorrectness in a specification, as there is no other formal model against which the specification can be compared—only the user's mental model to an informal written specification. The best that is possible is to analyze the specification and visualize it from different perspectives and ensure that each perspective matches with the behaviors that the user desired to capture.

In our illustration, we will simulate the specification and try various scenarios to ensure the correctness of the specification. A couple of scenarios that are expected are:

From an Init state, the sequence
<fail,fail,reset>
   should result in the target state satisfying Init. From an Automatic state, any sequence on the specification, and it is also possible to specify the corresponding simulation traces is also possible to specify the corresponding stimulation traces as simulation clauses in the specification. A more questionable scenario that can be simulated on the specification as it stands is as follows—starting from a Disabled state, the sequence, <fail,reset> will result in the state being Init.

In many domains, a Disabled state signifies that the component should not operate, and a special event is required make it operational. In particular, events such as failure and reset should not be allowed to change the state component if it is Disabled. Therefore, the above scenario is an anti-scenario.

The STS language allows the specification of such anti-scenarios, and it is possible to perform the above simulation and mark the simulation trace as an anti-scenario. In our case, when we perform this step, the algorithms immediately point out an inconsistency in the specification. This is because, earlier in the specification, we have specified the clauses:

$$true \begin{matrix}fail \\ notify\end{matrix} fail$$

$$true \begin{matrix}reset \\ ∈\end{matrix} off$$

which specify a transition on the fail and reset events from all states. In order to be consistent with the anti-scenario, these clauses have to be changed to:

$$Disabled \begin{matrix}fail \\ notify\end{matrix} fail$$

$$Disabled \begin{matrix}reset \\ ∈\end{matrix} off$$

Further, clauses have to be added to specify the behavior in the Disabled state, in order to make the specification complete:

$$Disabled \begin{matrix}fail \\ notify\end{matrix} Disabled$$

$$Disabled \begin{matrix}reset \\ ∈\end{matrix} Disabled$$

At this stage, the specification is consistent, complete and presumably correct. The hierarchical nature of textual STS specifications are represented using a tree where the non-leaf nodes of the specification are either zoom or focus clauses that contain a sub-specification. The prototype tool supports all the analyses that we have described in the paper. Each analysis can be performed at the top level of the specification or with respect to particular sub-specifications corresponding to a zoom or focus clause.

It is to be understood that the above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that further developments will occur in the arts discussed herein, and that the disclosed systems and methods will be incorporated into such further examples. In sum, it should be understood that the invention is capable of modification and variation and is limited only by the following claims.

The present embodiments have been particular shown and described, which are merely illustrative of the best modes. It should be understood by those skilled in the art that various alternatives to the embodiments described herein may be employed in practicing the claims without departing from the spirit and scope of the invention and that the method and system within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable construction and their ordinary meaning as understood by those skilled in the art unless an explicit indication to the contrary is made herein. In particular, use of the singular articles such as “a”, “the”, “said”, etc. should be read to recite one or more of the indicated elements unless a claim recites an explicit limitation to the contrary.

What is claimed is:

1. A method for developing a specification, the method comprising the steps of:
receiving a plurality of requirements that define the functionality of the specification, wherein the plurality of requirements are expressed using a formal model;
simulating the plurality of requirements using formal analysis;
determining if the plurality of requirements satisfies a predetermined set of criteria;
generating a summary of the formal analysis; and
modifying at least one of the plurality of requirements if at least one of the predetermined set of criteria is not satisfied.

2. The method of claim 1, further including modifying the generated summary and using this modified summary as a specification item, thereby refining the specification.

3. The method of claim 2, further including iteratively refining the specification using feedback provided by the formal analysis.

4. The method of claim 3, wherein the steps of simulating the plurality of requirements, determining if the requirements satisfy the set of criteria, and generating a summary are repeated using the modified summary.

5. The method of claim 1, wherein the summary of the formal analysis indicates if the plurality of requirements satisfies the predetermined set of criteria.

6. The method of claim 1, wherein simulating the plurality of requirements using formal analysis includes analyzing the requirements using at least one algorithm.

7. The method of claim 1, wherein determining if the plurality of requirements satisfies a predetermined set of criteria includes determining if the requirements are at least one of complete, correct, consistent and non-ambiguous.

8. The method of claim 1, further including amending the portion of the requirements that does not satisfy the predetermined set of criteria.

9. The method of claim 8, further including incorporating the amended portion of the requirements into the specification.

10. The method of claim 1, wherein the formal model is in the form of a state machine, a scenario or structured English.

11. The method of claim 1, wherein the modified summary is incorporated into the specification to refine the specification.

12. A method, comprising the steps of:
receiving a plurality of requirements that define the functionality of a specification, wherein the plurality of requirements are expressed using a formal model;
testing the plurality of requirements for defects using formal analysis;
generating a summary that includes the results of the formal analysis; and
refining the plurality of requirements by incorporating the results of the formal analysis into the specification as specification items.

13. The method of claim 12, wherein testing the plurality of requirements for defects using formal analysis includes determining the behavior of the specification.

14. The method of claim 13, wherein refining the plurality of requirements based on the results of the formal analysis includes correcting defects by specifying an expected defect-free summary.

15. The method of claim 14, further including incorporating the expected defect-free summary into the specification.

16. The method of claim 12, wherein testing the plurality of requirements for defects using formal analysis includes analyzing the requirements using at least one algorithm.

17. The method of claim 12, wherein testing the plurality of requirements for defects includes determining if the plurality of requirements is one or more of incomplete, incorrect, inconsistent or ambiguous.

18. A system for developing a specification, the system comprising:
a database configured to receive a plurality of requirements; and
an analysis engine configured to simulate the plurality of requirements using formal analysis, wherein the formal analysis identifies defects in the requirements;
wherein the requirements are refined to correct the defects and the refined requirements are incorporated into the specification.

19. The system of claim 18, wherein the analysis engine generates a summary of the formal analysis.

20. The system of claim 18, wherein the formal analysis applies a plurality of algorithms to the requirements to determine if the requirements are at least one of incomplete, incorrect, inconsistent or ambiguous.
